(19) United States
(12) Patent Application Publication
(10) Pub. No.: US 2008/0304902 A1
(43) Pub. Date: Dec. 11, 2008

(54) Ball joint

(76) Inventors: Tomasz Buchner, Sterling Heights, MI (US); Swaminathan Krishnan, Sterling Heights, MI (US)

Correspondence Address: MACMILLAN, SOBANSKI & TODD, LLC, ONE MARITIME PLAZA - FIFTH FLOOR, 720 WATER STREET, TOLEDO, OH, 43604, US

(21) Appl. No.: 11/591,293

(22) Filed: Nov. 1, 2006

(51) Int. Cl. F16C 11/06

(52) U.S. Cl. 403/76

(57) ABSTRACT

An improved ball joint for use in such a motor vehicle steering or suspension system comprises a socket shell having a pair of openings; a bearing disposed in the socket shell; a first ball stud portion and a second ball stud portion disposed in the socket shell, the first ball stud portion defining a first bearing surface and the second stud portion defining a second bearing surface; and ball stud disposed between the bearing and the first and second ball stud portions, the ball stud having an inner surface seated on the first bearing surface of the first ball stud portion and the second bearing surface of the second ball stud portion.

### BACKGROUND OF THE INVENTION

This invention relates in general to vehicle steering or suspension systems and in particular to an improved ball joint for use in such a motor vehicle steering or suspension system.

Ball joints provide an articulated connection between two relatively movable parts. Ball joints are commonly used in motor vehicle steering systems and in motor vehicle suspension systems.

In a vehicle steering system, ball joints are commonly adapted to be connected to a steering arm of each of a wheel knuckle. Typically, a ball joint for a motor vehicle steering system includes a ball stud with a spherical ball end and a housing or socket member with a spherical socket. A bearing member in the socket receives the ball end and supports the ball end for rotational and pivotal movement.

### SUMMARY OF THE INVENTION

This invention relates to an improved ball joint for use in such a motor vehicle steering or suspension system. According to a preferred embodiment, the ball joint comprises a socket shell having a pair of openings; a bearing disposed in the socket shell; a first ball stud portion and a second ball stud portion disposed in the socket shell, the first ball stud portion defining a first bearing surface and the second stud portion defining a second bearing surface; and ball stud disposed between the bearing and the first and second ball stud portions, the ball stud having an inner surface seated on the first bearing surface of the first ball stud portion and the second bearing surface of the second ball stud portion.

### BRIEF DESCRIPTION OF THE DRAWINGS

FIG. 1 is a sectional view of a portion of a prior art ball joint.

FIG. 2 is a sectional view of an embodiment n exploded view of the prior art ball joint illustrated in FIG. 1.

FIG. 3 is a sectional view of an embodiment of a ball joint.

FIG. 4 is an exploded view of selected components of the ball joint illustrated in FIG. 3.

FIG. 5 is an enlarged view of a portion of the ball joint shown in FIG. 3.

### DETAILED DESCRIPTION OF THE INVENTION

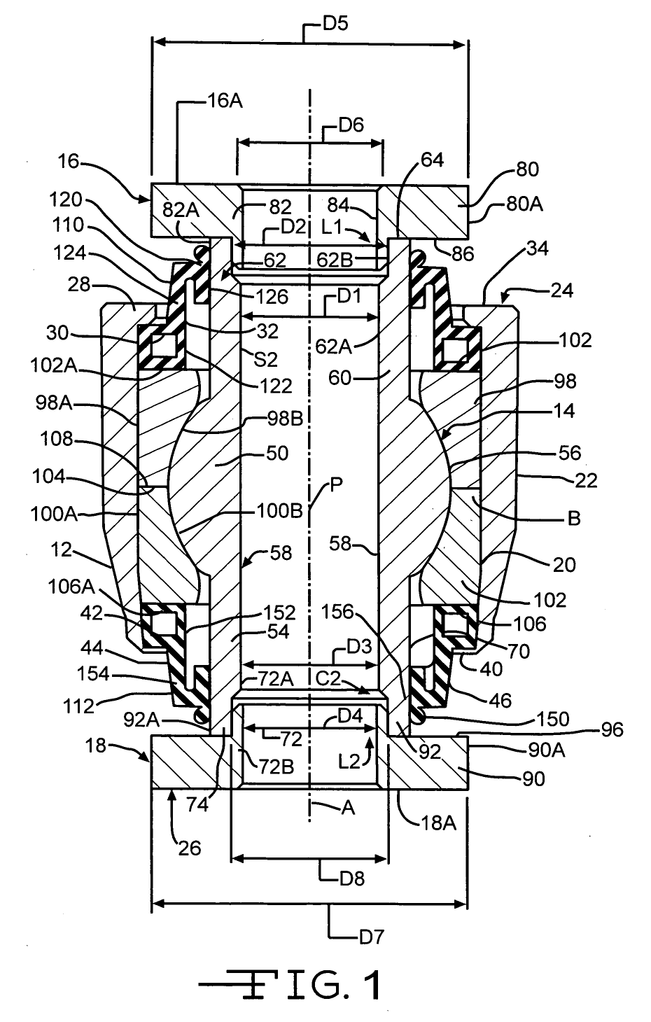

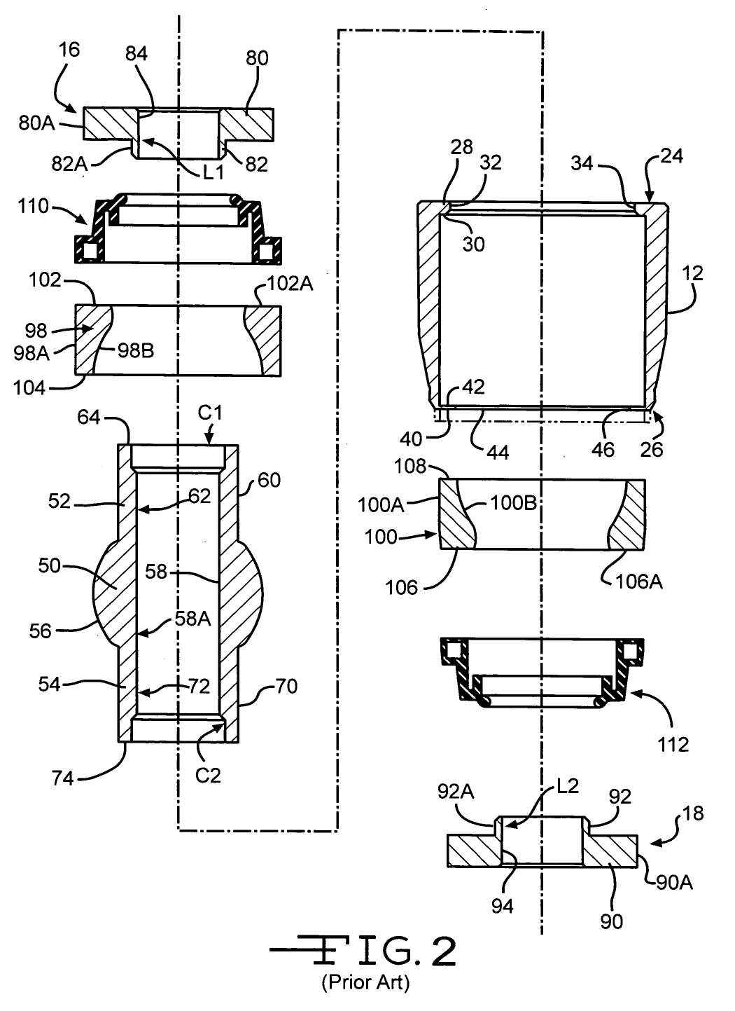

Referring now to FIGS. 1 and 2, there is illustrated a portion of a prior art a ball joint, indicated generally at 10. The general structure and operation of the prior art ball joint 10 is conventional in the art. Thus, only those portions of the prior art ball joint 10 which are necessary for a full understanding of this invention will be explained and illustrated in detail. As is well known in the art, the prior art ball joint 10 interconnects relatively movable vehicular parts, such as for example, a steering knuckle or steering yoke, with a control arm, steering yoke or steering knuckle.

As shown in prior art FIG. 1, the ball joint 10 defines an axis A and includes a socket shell or housing 12, a ball stud 14, a first washer 16, and a second washer 18. The socket shell 12 is formed of a rigid material, such as for example, steel, and is centered on the axis A. The socket shell 12 has generally parallel, cylindrical inner and outer surfaces 20 and 22, respectively.

The socket shell 12 has a first end portion 24 and a second end portion 26. The first end portion 24 of the socket shell 12 is provided with a radially inwardly extending flange 28. As best shown in prior art FIG. 2, the flange 28 has a generally radially extending first surface 30 and a generally axially extending second surface 32. The second surface 32 in the first end portion 24 of the socket shell 12 defines a first opening 34 in the socket shell 12.

The second end portion 26 of the socket shell 12 includes a radially inwardly extending “crimpable” flange 40 which has a crimped position (shown in prior art FIG. 1), and an uncrimped position (shown in phantom in prior art FIG. 2). In the crimped position, the flange 40 has a generally radially extending first surface 42 and an axially extending second surface 44. In the crimped position, the second portion 44 of the flange 40 of the socket shell 12 defines a second opening 46 in the socket shell 12.

The ball stud 14 is formed from a suitable material, such as steel, and is centered on the axis A. The ball stud 14 includes a central ball portion 50, a first or “upper” stud portion 52 and a second or “lower” stud portion 54. The stud portions 52 and 54 extend from the central ball portion 50 in diametrically opposite directions. The central ball portion 50 has a substantially spherical outer surface 56 centered on a pivot center P.

The central ball portion 50 includes a cylindrical inner surface 58 which defines a central passage 58A through the ball stud 14. The central passage 58A is centered on the axis A and extends completely through the ball joint 10 from an end surface 16A of the first washer 16, through the central ball portion 50, and to an end surface 18A of the second washer 18.

The central ball portion 50 has a centerline B which extends perpendicular to the axis A. The pivot center P of the ball joint 10 is located on the axis A at the intersection of the axis A and the centerline B. The first and second stud portions 52 and 54 are centered on the axis B.

As best shown in prior art FIG. 2, the first stud portion 52 has a cylindrical outer surface 60 and a stepped cylindrical inner surface, indicated generally at 62. The stepped cylindrical inner surface 62 includes a cylindrical inner first surface 62A and a cylindrical inner second surface 62B. The cylindrical inner first surface 62A defines a first inner diameter D1 and the cylindrical inner second surface 62B defines a second inner diameter D2 which is greater than the first inner diameter D1 so as to define a counterbore, indicated generally at C1, therein. The first stud portion 52 further includes a generally planar end surface 64 which is generally perpendicular to the axis A.

The second stud portion 54 has a cylindrical outer surface 70 and a stepped cylindrical inner surface, indicated generally at 72. The stepped cylindrical inner surface 72 includes a cylindrical inner first surface 72A and a cylindrical inner second surface 72B. The cylindrical inner first surface 72A defines a first inner diameter D3 and the cylindrical inner second surface 72B defines a second inner diameter D4 which is greater than the first inner diameter D3 so as to define a counterbore, indicated generally at C2, therein. The first stud portion 54 further includes a generally planar end surface 74 which is generally perpendicular to the axis A.

The first washer 16 is generally annular and is formed from a suitable material, such as for example metal. The first washer 16 includes a first portion 80 and a second portion 82 and has a cylindrical inner surface 84. The first portion 80 is an enlarged diameter flanged portion which has an outer cylindrical surface 80A. The flanged first portion 80 is adapted to be connected to a suitable vehicle suspension component, such as for example a knuckle or yoke of a suspension component, in a known manner.

The outer cylindrical surface 80A defines a first outer diameter D5 of the first washer 16. The second portion 82 has an outer cylindrical surface 82A which defines a second outer diameter D6 of the first washer 16 and which is less than the first outer diameter D5 so as to define a lip, indicated generally at L1. The first washer 16 further includes an axially extending surface or shoulder 86 which extends generally perpendicular to the axis A. In the prior art ball joint 10, the outer diameter D6 of the second portion 82 of the first washer 16 is slightly greater than the inner diameter D2 of the first stud portion 52 so that the lip L1 of the first washer 16 is received in the counterbore C1 of the first stud portion 52 in an interference or friction fit therewith.

The second washer 18 is generally annular and is formed from a suitable material, such as for example metal. The second washer 18 includes a first portion 90 and a second portion 92 and has a cylindrical inner surface 94. The first portion 90 is an enlarged diameter flanged portion which has an outer cylindrical surface 90A. The flanged first portion 90 is adapted to be connected to a suitable vehicle suspension component, such as for example a knuckle or yoke of a suspension component, in a known manner.

The outer cylindrical surface 90A defines a first outer diameter D7 of the second washer 18. The second portion 92 has an outer cylindrical surface 92A which defines a second outer diameter D8 of the second washer 18 and which is less than the first outer diameter D7 so as to define a lip, indicated generally at L2. The second washer 18 further includes an axially extending surface or shoulder 96 which extends generally perpendicular to the axis A. In the prior art ball joint 10, the outer diameter D8 of the second portion 94 of the second washer 18 is slightly greater than the inner diameter D4 of the second stud portion 54 so that the lip L2 of the second washer 18 is received in the counterbore C2 of the second stud portion 54 in an interference or friction fit therewith.

The prior art ball joint 10 further include first and second bearings 98 and 100, respectively, for supporting the central ball portion 50 of the ball stud 14 in the housing 12 for movement relative to the housing 12. The bearings 98 and 100 may be made of any suitable material, but typically are made of injection molded Delrin brand plastic which is available from E. I. DuPont de Nemours & Co. The bearings 98 and 100 are generally annular bearings and are centered on the axis A.

The first or “upper” bearing 98 has first and second end portions 102 and 104, respectively. The first bearing 98 includes a cylindrical outer surface 98A and a generally semi-spherical inner surface 98B which extend between the end portions 102 and 104. The first end portion 102 has a generally radially extending surface 102A that extends generally perpendicular to the axis A.

The second or “lower” bearing 100 has first and second end portions 106 and 108. The bearing 100 includes a cylindrical outer surface 100A and a generally semi-spherical inner surface 100B which extend between the end portions 106 and 108. The first end portion 106 has a generally radially extending surface 106A that extends generally perpendicular to the axis A.

The ball joint 10 includes first and second seals 110 and 112 for closing and sealing the first and second openings 34 and 46, respectively, in the socket shell 12. The first and second seals 110 and 112 are annular and are centered on the axis A. The seals 110 and 112 are preferably made of a suitable elastomeric material, but may be made of other suitable materials known in the art.

The first seal 110 includes a stud seal portion 120 and a bearing seal portion 122 which are connected by a connector portion 124. The stud seal portion 120 includes an axially extending surface 126 which defines a passage for receiving the first stud portion 52 of the ball stud 14. An S-shaped spring ring (not shown) is typically injection molded in the stud seal portion 120 of the first seal 110 and is embedded in the stud seal portion 120. The spring ring exerts a radially inward biasing force on the stud seal portion 120 of the first seal 110.

The first seal 110 typically includes an annular metal retaining ring (not shown) which is injection molded in the bearing seal portion 122 of the first seal 110. The retaining ring is generally square in cross-section and is surrounded on all four sides by the elastomeric material of the bearing seal portion 122.

The second seal 112 includes a stud seal portion 150 and a bearing seal portion 152 which are connected by a connector portion 154. The stud seal portion 150 includes an axially extending surface 156 which defines a passage or receiving the second stud portion 54 of the ball stud 14. An S-shaped spring ring (not shown) is typically injection molded in the stud seal portion 150 of the second seal 112 and is embedded in the stud seal portion 150. The spring ring exerts a radially inward biasing force on the stud seal portion 150 of the second seal 112.

The second seal 112 typically includes an annular metal retaining ring (not shown) which is injection molded in the bearing seal portion 152 of the second seal 112. The retaining ring is generally square in cross-section and is surrounded on all four sides by the elastomeric material of the bearing seal portion 152.

In the assembled and installed condition of the prior art ball joint 10, the socket shell 12 is installed in an opening provided in a suitable suspension component (not shown) in a well know manner. The socket shell 12 may be fixedly secured to the suspension component by press-fitting and/or welding the socket shell 12 in the opening of the suspension component. The socket shell 12 may be secured to the suspension component prior to assembly of the other components of the prior art ball joint 10 or as part of a complete ball joint assembly. The structure and operation of the prior art ball joint 10 thus far described is conventional in the art.

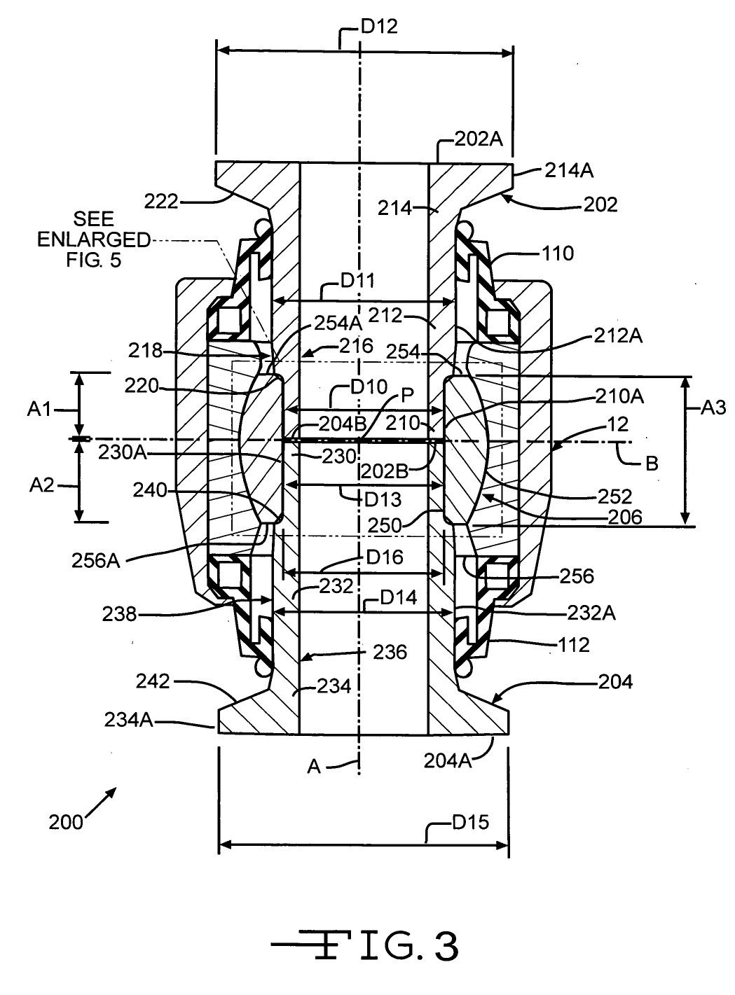

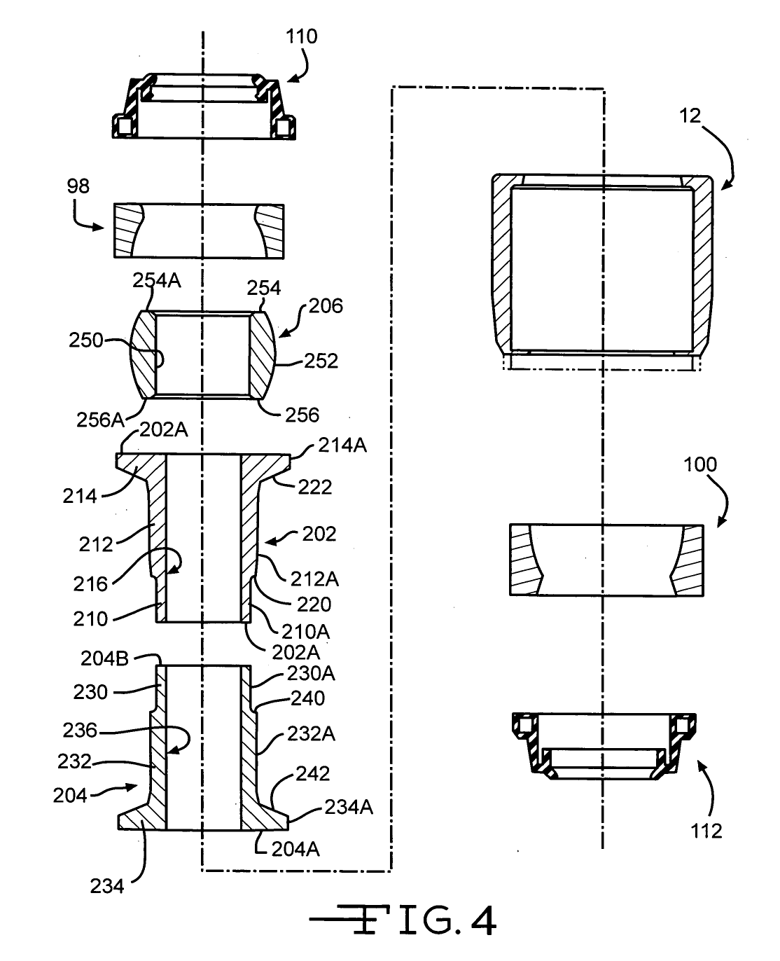

Turning now to FIGS. 3 and 4, and using like reference numbers to indicate corresponding parts, there is illustrated a preferred embodiment of a ball joint, indicated generally at 200. Although this invention will be described and illustrated in connection with the particular type of prior art ball joint disclosed herein, it will be appreciated that this invention may be used in connection with: other types of ball joints.

In the illustrated preferred embodiment, the ball joint 200 includes a first or “upper” stud or washer portion 202, a second or “lower” stud or washer portion 204, and a ball stud 206. In the illustrated embodiment, the first stud portion 202 is preferably formed from metal by may be formed from other suitable materials if so desired. The first stud portion 202 includes a first or “inner” portion 210, a second or “intermediate” portion 212 and a third or “outer” portion 214. The first stud portion 202 has an inner surface 216 and an outer surface 218.

In the illustrated embodiment, the inner surface 216 is preferably a constant cylindrical inner surface throughout its entire length from a first or “outer” end 202A of the first stud portion 202 to a second or “inner” end 202B of the first stud portion 202. In the illustrated embodiment, the outer surface 218 is stepped and includes a first cylindrical outer “bearing” surface 210A defined generally in the first portion 210, a second rounded or radiused outer surface 220 extending outwardly from the surface 210A, a third cylindrical outer surface 212A defined generally in the second portion 212, a fourth tapered outer surface 222 extending outwardly from the surface 212A, and a fifth cylindrical outer surface 214A defined generally in the third portion 214.

The first cylindrical outer surface 210A defines a first outer diameter D10 and extends an axial distance A1. The third cylindrical outer surface 212A defines a second outer diameter D11, and the fifth cylindrical outer surface 214A defines a third outer diameter D12. In the illustrated embodiment, the third outer diameter D12 is greater than the second outer diameter D11, and the second outer diameter D12 is greater than the first outer diameter D10. Alternatively, the construction of the first stud portion 202 may be other than illustrated if so desired.

In the illustrated embodiment, the second stud portion 204 is preferably formed from metal by may be formed from other suitable materials is so desired. The second stud portion 204 includes a first or “inner” portion 230, a second or “intermediate” portion 232 and a third or “outer” portion 234. The second stud portion 204 has an inner surface 236 and an outer surface 238.

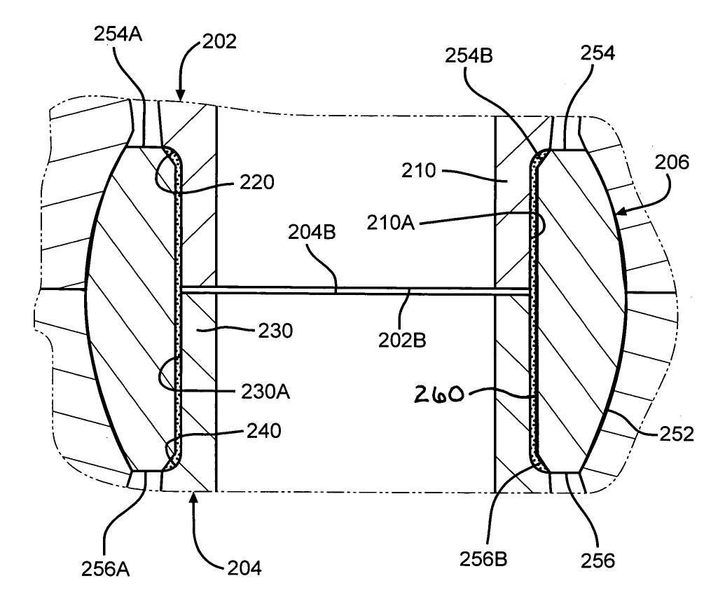

In the illustrated embodiment, the inner surface 226 is preferably a constant cylindrical inner surface throughout its entire length from a first or “outer” end 204A of the second stud portion 204 to a second or “inner” end 204B of the second stud portion 204. As best shown in the illustrated embodiment in FIG. 5, the inner end 202B of the first stud portion 202 is preferably slightly spaced apart from contacts with the inner end 204B of the second stud portion 204. Alternatively, there may be partial or full contact between the inner end 202B of the first stud portion 202 and the inner end 204B of the second stud portion 204 if so desired.

In the illustrated embodiment, the outer surface 238 is stepped and includes a first cylindrical outer “bearing” surface 230A defined generally in the first portion 230, a second rounded or radiused outer surface 240 extending outwardly from the surface 230A, a third cylindrical outer surface 232A defined generally in the second portion 232, a fourth tapered outer surface 242 extending outwardly from the surface 213A, and a fifth cylindrical outer surface 234A defined generally in the third portion 234.

The first cylindrical outer surface 230A defines a first outer diameter D13 and extends an axial distance A2. The third cylindrical outer surface 232A defines a second outer diameter D14, and the fifth cylindrical outer surface 234A defines a third outer diameter D15. In the illustrated embodiment, the third outer diameter D15 is greater than the second outer diameter D14 and the second outer diameter D14 is greater than the first outer diameter D13. Alternatively, the construction of one or both of the first stud portion 202 and the second stud portion 204 may be other than illustrated if so desired. For example, one or both of the stud portions 202 and 204 may have threaded ends such as shown in U.S. Pat. No. 5,931,597 to Urbach, the disclosure of this patent incorporated by reference in entirety herein. Also, in the illustrated embodiment, the construction of the ball stud portions 202 and 204 are shown as being identical to each other; however, the construction of the ball stud portions 202 and 204 may be different from one another if so desired. Also, the construction of one or both of the ball stud portions 202 and 204 may be other than illustrated if so desired.

The ball stud 206 is formed from a suitable material, such as for example steel, and includes an inner surface 250, and outer surface 252, a first end 254 and a second end 256. The inner surface 250 is preferably a constant cylindrical inner surface throughout its entire length from the first end 254 to the second end 256. The inner surface 250 defines an inner diameter D16 of the ball stud 206. The outer surface 252 is a substantially spherical outer surface and is centered on the pivot center P. Preferably, in the illustrated embodiment, the inner diameter D16 of the ball stud 206 is generally equal to or slightly less than the outer diameters D10 and D13 of the respective first portions 210 and 230 of the stud portions 202 and 204 so as to be disposed therein in a press or interference fit therewith.

In the illustrated embodiment, the first end 254 has a generally radially extending end surface 254A and the second end 256 has a generally radially extending end surface 256A. The end surface 254A and the end surface 256A are separated apart by one another by an axial distance A3. Preferably, in the illustrated embodiment, the axial distance A3 is slightly greater than the sum of the axial distances A1 and A2 of the respective first portions 210 and 230 of the stud portions 202 and 204. Also, as best shown in the illustrated embodiment in FIG. 5, the first end 254 is provided with a tapered portion 254B and the second end 256 is provided with a tapered portion 256B. Alternatively, the construction of the ball stud 206 may be other than illustrated if so desired.

In the illustrated embodiment, in order to ensure that the first portion 202, the second portion 204 and the ball stud 206, which are preferably secured together by a friction or interference fit therewith, remain secured to each other during shipment and prior to assembly, suitable means are preferably provided. In the illustrated embodiment, an adhesive 260 (shown in FIG. 5), is preferably utilized. In the illustrated embodiment, the adhesive 260 may be applied to the outer surfaces 210A and 230A of the first portions 210 and 230 of the stud portions 202 and 204 prior to assembling the ball stud 206 onto the stud portions 202 and 204. Any suitable adhesive 260 may be used, such as for example urethane, silicone, or thermal-setting adhesives. Alternatively, any other suitable adhesives may be used. Also, the adhesive 260 may not be used if so desired.

Also, in combination with or in place of using an adhesive, other suitable means may be used to the ensure that the first portion 202, the second portion 204 and the ball stud 206, which are preferably secured together by an friction or interference fit, remain secured to each other during shipment and prior to assembly. For example, the ball stud portions 202 and 204 may themselves have a construction or configuration which provides a sufficient interference fit or mechanical connection with each other, such as for example, a male portion(s) on one of the ball stud portions which is received in a female portion(s) provided on the other one of the ball stud portions or one of the ball stud portions may be provided with external threads which are threadably disposed in internal threads provided on the other one of the ball stud portions. Also, a band or other suitable retainer (not shown) may be installed around the ends 202A and 204A of the stud portions 202 and 204, respectively, during shipment and prior to assembly. Such a band or retainer may be temporary or permanent depending upon its design.

One possible or potential advantage of the embodiment of the ball joint 200 is that the ball stud 206 may be manufactured by production processes adopted for regular ball bearings, and the stud portions 202 and 204 may be cold formed and machined. The prior art ball stud 14 and washers 14 and 16 had an interference fit which used machining to tight tolerances. As result of this, the ball joint 200 may result in a reduction in manufacturing costs.

In accordance with the provisions of the patent statutes, the principle and mode of operation of this invention have been explained and illustrated in its various embodiments. However, it must be understood that this invention may be practiced otherwise than as specifically explained and illustrated without departing from its spirit or scope.

What is claimed is:

1. A ball joint comprising:
a socket shell having a pair of openings;
a bearing disposed in said socket shell;
a first ball stud portion and a second ball stud portion disposed in said socket shell, said first ball stud portion defining a first bearing surface and said second stud portion defining a second bearing surface; and
a ball stud disposed between said bearing and said first and second ball stud portions, said ball stud having an inner surface seated on said first bearing surface of said first ball stud portion and said second bearing surface of said second ball stud portion.

2. The ball joint of claim 1 wherein said first ball stud portion, said second ball stud portion and said ball stud are secured to one another.

3. The ball joint of claim 2 wherein said first ball stud portion, said second ball stud portion and said ball stud are secured to one another by mechanical means.

4. The ball joint of claim 2 wherein said first ball stud portion, said second ball stud portion and said ball stud are secured to one another by an interference fit therewith.

5. The ball joint of claim 2 further including an adhesive to assist in securing together said first ball stud portion, said second ball stud portion and said ball stud.

6. The ball joint of claim 1 wherein said first ball stud portion has a first portion defining a first inner diameter of said first ball stud portion, said second ball stud portion has a first portion defining a first inner diameter of said second ball stud portion, said first stud portion has a first inner end and a first outer end, said second stud portion has a first inner end and a first outer end, said first inner ends of said first and second ball stud portions are slightly spaced apart from contact with one another.

7. The ball joint of claim 6 wherein said ball stud has an inner surface defining an inner diameter of said ball stud, said inner diameter of said ball stud generally equal to said first inner diameter of said first ball stud portion and said first outer diameter of said first portion of said second ball stud portion.

8. The ball joint of claim 1 further including a seal provided at each of said openings of said socket shell.

9. The ball joint of claim 1 wherein said first ball stud portion and said second ball stud portion are identical to one another.

10. The ball joint of claim 1 wherein an internal passageway is formed through said ball joint, said internal passageway being defined only by inner surfaces of said first and said second ball stud portions.

11. The ball joint of claim 1 wherein said bearing includes a first bearing member and a second bearing member.

12. A ball joint comprising:
a socket shell having a pair of openings;
a bearing disposed in said socket shell;
a first ball stud portion and a second ball stud portion disposed in said socket shell, said first ball stud portion defining a first bearing surface and said second stud portion defining a second bearing surface, said first ball stud portion including an inner surface and said second ball stud portion including an inner surface; and
a ball stud disposed between said bearing and said first and second ball stud portions, said ball stud having an inner surface seated on said first bearing surface of said first ball stud portion and said second bearing surface of said second ball stud portion;
wherein said first ball stud portion, said second ball stud portion and said ball stud are secured to one another and wherein an internal passageway is formed through said ball joint, said internal passageway being defined only said inner surfaces of said first and said second ball stud portions.

13. The ball joint of claim 12 wherein said first ball stud portion, said second ball stud portion and said ball stud are secured to one another by mechanical means.

14. The ball joint of claim 12 wherein said first ball stud portion, said second ball stud portion and said ball stud are secured to one another by an interference fit therewith.

15. The ball joint of claim 12 further including an adhesive to assist in securing together said first ball stud portion, said second ball stud portion and said ball stud.

16. The ball joint of claim 12 wherein said first ball stud portion has a first portion defining a first inner diameter of said first ball stud portion, said second ball stud portion has a first portion defining a first inner diameter of said second ball stud portion, said first stud portion has a first inner end and a first outer end, said second stud portion has a first inner end and a first outer end, said first inner ends of said first and second ball stud portions are slightly spaced apart from contact with one another.

17. The ball joint of claim 16 wherein said ball stud has an inner surface defining an inner diameter of said ball stud, said inner diameter of said ball stud generally equal to said first inner diameter of said first ball stud portion and said first outer diameter of said first portion of said second ball stud portion.

18. The ball joint of claim 12 further including a seal provided at each of said openings of said socket shell.

19. The ball joint of claim 12 wherein said bearing includes a first bearing member and a second bearing member.

20. A ball joint comprising:
a socket shell having a pair of openings;
a seal provided at each of said openings of said socket shell
a bearing assembly disposed in said socket shell;
a first ball stud portion and a second ball stud portion disposed in said socket shell, said first ball stud portion defining a first bearing surface and said second stud portion defining a second bearing surface, said first ball stud portion including an inner surface and said second ball stud portion including an inner surface; and
a ball stud disposed between said bearing assembly and said first and second ball stud portions, said ball stud having an inner surface seated on said first bearing surface of said first ball stud portion and said second bearing surface of said second ball stud portion;
wherein said first ball stud portion, said second ball stud portion and said ball stud are secured to one another and wherein an internal passageway is formed through said ball joint, said internal passageway being defined only said inner surfaces of said first and said second ball stud portions.
